(19) United States
(12) Patent Application Publication
(10) Pub. No.: US 2026/0238017 A1
(43) Pub. Date: Aug. 13, 2026

(54) GRID-FORMING ISLAND DETECTION AND CONTINUOUS OPERATION OF AN INVERTER-BASED RESOURCE

(71) Applicant: GE VERNOVA RENOVABLES ESPAÑA, S.L., Barcelona (ES)

(72) Inventors: Dustin F. Howard, Brookhaven, GA (US); Ignacio Vieto, Cranston, RI (US)

(21) Appl. No.: 19/154,591

(22) PCT Filed: Feb. 9, 2023
(86) PCT No.: PCT/US2023/012667

§ 371 Date: Aug. 7, 2025

(51) Int. Cl. H02J 3/388; H02J 3/0012; H02J 3/38; H02J 101/28; H02K 7/18

(52) U.S. Cl. CPC H02J 3/388; H02J 3/0012; H02J 3/381; H02K 7/183; H02J 2101/28

(57) ABSTRACT

A method for controlling an inverter-based resource (IBR) connected to an electrical grid includes operating the IBR in a normal mode of operation. The method also includes receiving one or more electrical feedbacks and control signals. Further, the method includes determining whether the signals are indicative of an islanding condition occurring in the IBR. Moreover, upon the signals being indicative of the islanding condition, the method includes switching to an island mode of operation for the IBR. The island mode of operation includes continuously monitoring the signals, continuing operation of the IBR in the island mode of operation for as long as the signals indicate the islanding condition and an amount of loading is below at least one of available power or energy at the IBR. Further, the method includes reverting to the normal mode of operation when the signals indicate that the electrical grid is restored.

### FIELD

The present disclosure relates in general to inverter-based resources, and more particularly to grid-forming detection and continuous operation of an inverter-based resource during one or more islanding conditions.

### BACKGROUND

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known airfoil principles. For example, rotor blades typically have the cross-sectional profile of an airfoil such that, during operation, air flows over the blade producing a pressure difference between the sides. Consequently, a lift force, which is directed from a pressure side towards a suction side, acts on the blade. The lift force generates torque on the main rotor shaft, which is typically geared to a generator for producing electricity.

Wind turbines can be distinguished in two types: fixed speed and variable speed turbines. Conventionally, variable speed wind turbines are controlled as current sources connected to a power grid. In other words, the variable speed wind turbines rely on a grid frequency detected by a phase locked loop (PLL) as a reference and inject a specified amount of current into the grid. The conventional current source control of the wind turbines is based on the assumptions that the grid voltage waveforms are fundamental frequency voltage waveforms with fixed frequency and magnitude and that the penetration of wind power into the grid is low enough so as to not cause disturbances to the grid voltage magnitude and frequency. Thus, the wind turbines simply inject the specified current into the grid based on the fundamental voltage waveforms. However, with the rapid growth of the wind power, wind power penetration into some grids has increased to the point where wind turbine generators have a significant impact on the grid voltage and frequency. When wind turbines are located in a weak grid, wind turbine power fluctuations may lead to an increase in magnitude and frequency variations in the grid voltage. These fluctuations may adversely affect the performance and stability of the PLL and wind turbine current control.

Furthermore, many existing renewable generation converters, such as double-fed wind turbine generators, operate in a “grid-following” mode. Grid-following (GFL) type devices utilize fast current-regulation loops to control active and reactive power exchanged with the grid. More specifically, FIG. 1 illustrates the basic elements of the main circuit and converter control structure for a grid-following double-fed wind turbine generator. As shown, the active power reference to the converter is developed by the energy source regulator, e.g., the turbine control portion of a wind turbine. This is conveyed as a torque reference which represents the lesser of the maximum attainable power from the energy source at that instant, or a curtailment command from a higher-level grid controller. The converter control then determines a current reference for the active component of current to achieve the desired torque. Accordingly, the double-fed wind turbine generator includes functions that manage the voltage and reactive power in a manner that results in a command for the reactive component of current. Wide-bandwidth current regulators then develop commands for voltage to be applied by the converters to the system, such that the actual currents closely track the commands.

Alternatively, grid-forming (GFM) type converters provide a voltage-source characteristic, where the angle and magnitude of the voltage are controlled to achieve the regulation functions needed by the grid. With this structure, current will flow according to the demands of the grid while the converter contributes to establishing a voltage and frequency for the grid. This characteristic is comparable to conventional generators based on a turbine driving a synchronous machine. Thus, a GFM source must include the following basic functions: (1) support grid voltage and frequency for any current flow within the rating of the equipment, both real and reactive; (2) prevent operation beyond equipment voltage or current capability by allowing grid voltage or frequency to change rather than disconnecting equipment (disconnection is allowed only when voltage or frequency are outside of bounds established by the grid entity); (3) remain stable for any grid configuration or load characteristic, including serving an isolated load or connected with other grid-forming sources, and switching between such configurations; (4) share total load of the grid among other grid-forming sources connected to the grid; (5) ride through grid disturbances, both major and minor, and (6) meet requirements (1)-(5) without requiring fast communication with other control systems existing in the grid, or externally-created logic signals related to grid configuration changes.

The basic control structure to achieve the above GFM objectives was developed and field-proven for battery systems in the early 1990's (see e.g., U.S. Pat. No. 5,798,633 entitled “Battery Energy Storage Power Conditioning System”). Applications to full-converter wind generators and solar generators are disclosed in United States Publication No.: 2010/0142237 entitled “System and Method for Control of a Grid Connected Power Generating System,” and U.S. Pat. No. 9,270,194 entitled “Controller for controlling a power converter.” However, such implementations have been employed on full-converter wind generators.

GFL wind turbines are generally designed to operate with a relatively strong grid connection. As a result of certain grid events or grid operator actions, a wind farm may become isolated from the main grid. This operating condition, known as an island condition, is characterized by a network where the wind turbine(s) are the main generator in the remaining island system. The island may also contain loads, transformers, transmission lines, or other grid-following resources, but has a very small amount or no synchronous machines. Accordingly, existing GFL wind turbine generator (WTG) technology contains islanding detection algorithms designed to detect whether the WTG is operating in an islanding condition and then shut down the wind turbine to avoid adverse equipment implications or instabilities.

GFM wind turbines, however, can remain stable even without a strong grid connection and are therefore not necessarily required to shut down if an islanding condition is detected. In addition, in some circumstances, it may be beneficial to stay online temporarily or operate continuously during islanding conditions to continue serving some loads within the grid and/or wind farm.

However, continuous island operation can present some challenges for a GFM wind turbine. In particular, such challenges may include maintaining generation/load balance when both load and energy input from wind are changing, loss of control over active and reactive power of the WTG (since they are determined by loads), and/or stabilizing drivetrain oscillations (due to loss of power control).

In view of the foregoing, the present disclosure is directed to grid-forming detection and continuous operation of an inverter-based resource during one or more islanding conditions.

### BRIEF DESCRIPTION

Aspects and advantages of the invention will be set forth in part in the following description, or may be obvious from the description, or may be learned through practice of the invention.

In an aspect, the present disclosure is directed to a method for controlling an inverter-based resource connected to an electrical grid. The method includes operating the inverter-based resource in a normal mode of operation. The method also includes receiving, via a controller, one or more electrical feedbacks and control signals. Further, the method includes determining, via the controller, whether the one or more electrical feedbacks and control signals are indicative of an islanding condition occurring in the inverter-based resource. Upon the one or more electrical feedbacks and control signals being indicative of the islanding condition, the method includes switching to an island mode of operation for the inverter-based resource. The island mode of operation includes continuously monitoring the one or more electrical feedbacks and control signals and continuing operation of the inverter-based resource in the island mode of operation for as long as the one or more electrical feedbacks and control signals indicate the islanding condition and an amount of loading is below at least one of available power or energy at the inverter-based resource. Further, the method includes reverting to the normal mode of operation when the one or more electrical feedbacks and control signals indicate that the electrical grid is restored.

In another aspect, the present disclosure is directed to a wind turbine having a generator, a power converter coupled to the generator, and a controller having at least one processor configured to perform a plurality of operations. The plurality of operations include receiving one or more electrical feedbacks and control signals; determining whether the one or more electrical feedbacks and control signals are indicative of an islanding condition occurring in the wind turbine; and upon the one or more electrical feedbacks and control signals being indicative of the islanding condition, switching to an island mode of operation for the wind turbine. The island mode of operation includes continuously monitoring the one or more electrical feedbacks and control signals and continuing operation of the wind turbine in the island mode of operation for as long as the one or more electrical feedbacks and control signals indicate the islanding condition and an amount of loading is below at least one of available power or energy at the inverter-based resource. The plurality of operations further comprises reverting to the normal mode of operation when the one or more electrical feedbacks and control signals indicate that the electrical grid is restored.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a one-line diagram of a double-fed wind turbine generator with structure of converter controls for grid-following application according to conventional construction;

FIG. 2 illustrates a perspective view of one embodiment of a wind turbine according to the present disclosure;

FIG. 3 illustrates a simplified, internal view of one embodiment of a nacelle according to the present disclosure;

FIG. 4 illustrates a schematic view of one embodiment of a wind turbine electrical power system suitable for use with the wind turbine shown in FIG. 1;

FIG. 5 illustrates a schematic view of one embodiment of a wind farm having a plurality of wind turbines according to the present disclosure;

FIG. 6 illustrates a block diagram of one embodiment of a controller according to the present disclosure;

FIG. 7 illustrates a one-line diagram of a double-fed wind turbine generator with converter controls for grid-forming application according to the present disclosure;

FIG. 8 illustrates a flow diagram of an embodiment of a method for controlling a grid-forming inverter-based resource connected to an electrical grid according to the present disclosure;

FIG. 9 illustrates a schematic diagram of an embodiment of a GFM WTG with islanding detection and continuous operation control being implemented in a system according to the present disclosure;

FIG. 10 illustrates a schematic diagram of an embodiment of an angle/power sensitivity calculation module of a system according to the present disclosure;

FIG. 11 illustrates a schematic diagram of an embodiment of an angle/power sensitivity calculation of a voltage-based load management module of a system according to the present disclosure; and

FIG. 12 illustrates a schematic diagram of an embodiment of a system for operating a GFL WTG that may switch to GFM controls in an island condition according to the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “coupled,” “fixed,” “attached to,” and the like refer to both direct coupling, fixing, or attaching, as well as indirect coupling, fixing, or attaching through one or more intermediate components or features, unless otherwise specified herein.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Generally, the present disclosure is directed to systems and methods for controlling a grid-forming (GFM) inverter-based resource (IBR), such as a wind turbine, connected to an electrical grid. In particular, the present disclosure is directed to a system and method for detecting an island condition and changing the mode of operation of the IBR in such a way that temporary or continuous operation in the island may be possible despite the challenges described herein. An island condition may represent a complete disconnection of the IBR or group of IBRs from the grid (or possibly with the IBR or group of IBRs remaining connected only to loads). In this case, the IBR or group of IBRs are the only generator in the island serving the loads. In other (e.g., less extreme) cases, an island condition may represent a disconnection of a portion of the local grid from the rest of the bulk power system. In this case, the IBR or group of IBRs are one of a relatively few number of generators serving the load within the island. This condition may be reflected as a grid connection with very low inertia or very weak connection.

Accordingly, in certain embodiments, the system receives electrical feedbacks and control signals, such as voltage feedbacks, frequency feedbacks (e.g., from the phase-locked loop (PLL)), and active power feedback. In particular embodiments, such as for a GFM wind-turbine, the system may also receive control feedbacks such as a power error signal and an angle command. Thus, the system determines whether the feedbacks/control signals are indicative of an island condition. For a GFL wind-turbine, for example, high voltage feedbacks (e.g., above 1.3 pu) or high frequency feedbacks (e.g., above 1.05 pu frequency), or low power feedbacks (e.g., below 0.1 pu), or combinations of these, may be indicators of an island condition. For a GFM wind turbine, these indicators may be less reliable indication of an island because the GFM wind turbines maintain very stable voltage and frequency (even in an island). Therefore, GFM wind turbines may have additional logic to detect an insensitivity in active power to angle command in a certain frequency range to determine whether the system is an island condition. Additionally, an external signal (e.g., IsldForce 315) from higher level control (e.g., such as a farm-level controller) may be received that force island operation.

Once the island condition is detected, the system is configured to switch to an island mode of operation. In certain embodiments, at a minimum, this includes enabling a “power decoupling device” to help manage drivetrain related oscillations and decouple drivetrain oscillations between turbines. This enablement is only required if the power decoupler is a purely dissipative power/energy source (e.g., dynamic brake or AC connected converter with resistive components). If the enablement is based on an energy storage device, then it will always remain enabled, so operation may not require a special enable signal during island condition. If the power decoupler is a dissipative device, the island operation may only be maintained temporarily, as the time duration of operation may be constrained to avoid overheating the dissipative device. If it is an energy storage device, continuous island operation may be possible. Other actions that may be taken when transitioning to an island mode of operation may include one or more of the following: if the IBR is a GFL wind turbine, switch to GFM controls; enable a voltage-based load manager to reduce voltage reference of the system is frequency drops too low (e.g. indicating more load than available power, thereby reducing the active power load if there are resistive loads within the island); notify higher level controls (e.g., turbine controller or farm-level controller) that an island condition is detected, which may require higher level controls to change their mode of operation; and/or change one or more gains of various controls (e.g., limits on frequency droop function).

Moreover, in an embodiment, the system is configured to continue operation of the WTG in the island while supporting voltage and frequency. Support of the voltage may be handled through a grid volt/VAR control in the WTG. Support of the frequency can be handled by the inertial power regulator with inertia characteristic and frequency droop. Furthermore, the system is configured to monitor the electrical feedbacks and control signals. In particular embodiments, frequency feedback and a calculated rate of change of frequency (e.g., via a washout function) may be monitored.

Accordingly, the system is configured to determine whether the electrical feedbacks and control signals indicate a normal (non-island) grid condition has been restored. In certain embodiments, a rate-of-change-of-frequency (ROCOF) signal that has been relatively small for a predetermined period of time may be a good indicator of normal grid condition. Alternatively, a frequency feedback remaining close to a nominal grid frequency for a predetermined period of time may also be a good indicator that normal grid condition is present. In addition, the system is configured to determine whether the amount of load exceeds available generation. In particular embodiments, sustained frequency feedback below nominal (or another predetermined threshold) for an extended duration may indicate excessive load. Similarly, a consistent negative rate of change of frequency for a certain duration may indicate excessive load.

If the electrical feedbacks and control signals indicate a normal (non-island) grid condition has been restored and the amount of load does not exceed available generation, then the system is configured to switch back to a normal (non-island) mode of operation. For example, in an embodiment, if the IBR is a GFL wind turbine, the system is configured to switch from GFM controls back to GFL controls.

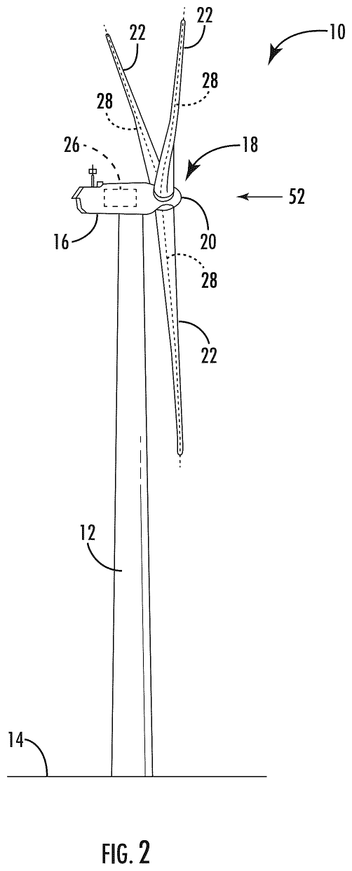

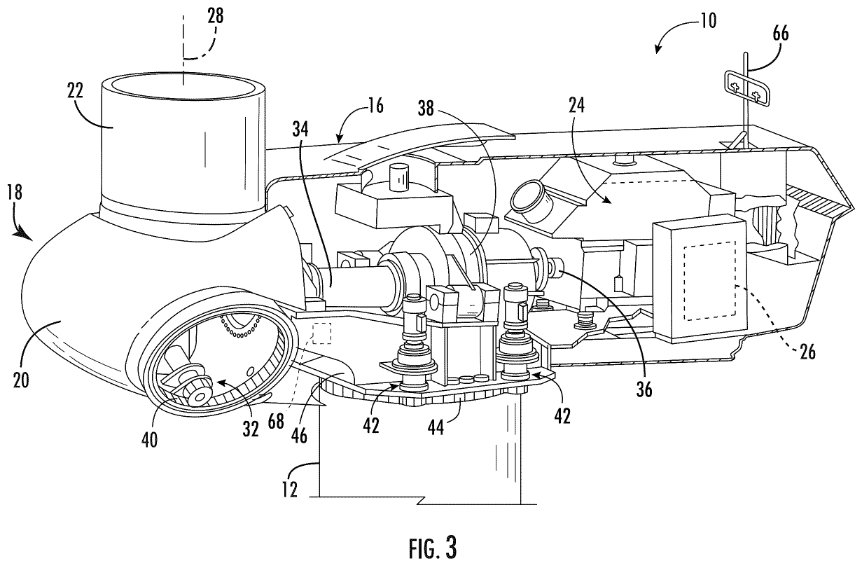

Referring now to the drawings, FIG. 2 illustrates a perspective view of one embodiment of a wind turbine 10 according to the present disclosure. As shown, the wind turbine 10 generally includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator 24 (FIG. 3) positioned within the nacelle 16 to permit electrical energy to be produced.

The wind turbine 10 may also include a wind turbine controller 26 centralized within the nacelle 16. However, in other embodiments, the controller 26 may be located within any other component of the wind turbine 10 or at a location outside the wind turbine 10. Further, the controller 26 may be communicatively coupled to any number of the components of the wind turbine 10 in order to control the operation of such components and/or implement a corrective or control action. As such, the controller 26 may include a computer or other suitable processing unit. Thus, in several embodiments, the controller 26 may include suitable computer-readable instructions that, when implemented, configure the controller 26 to perform various different functions, such as receiving, transmitting and/or executing wind turbine control signals. Accordingly, the controller 26 may generally be configured to control the various operating modes (e.g., start-up or shut-down sequences), de-rating or up-rating the wind turbine, and/or individual components of the wind turbine 10.

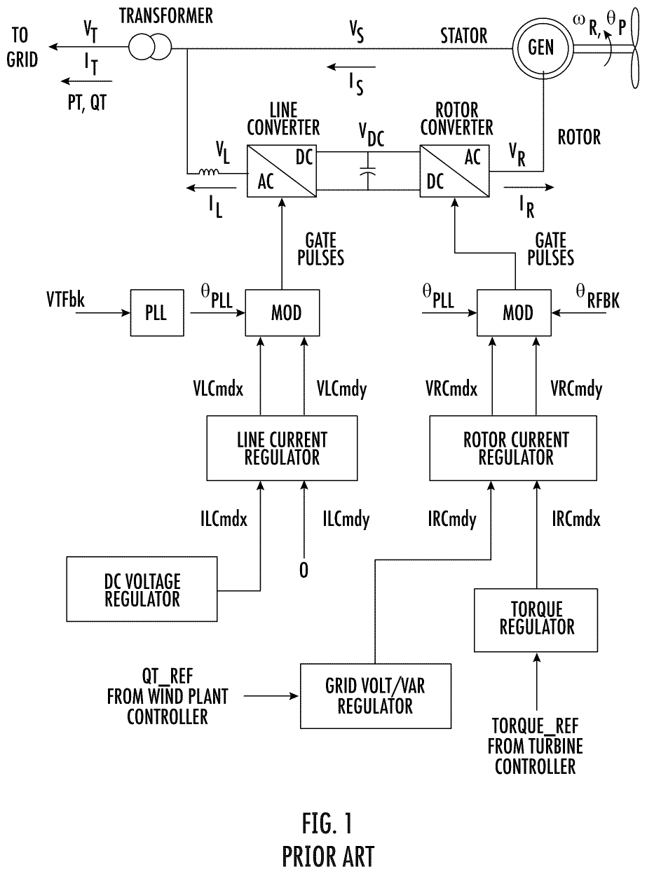

Referring now to FIG. 2, a simplified, internal view of one embodiment of the nacelle 16 of the wind turbine 10 shown in FIG. 1 is illustrated. As shown, a generator 24 may be disposed within the nacelle 16 and supported atop a bedplate 46. In general, the generator 24 may be coupled to the rotor 18 for producing electrical power from the rotational energy generated by the rotor 18. For example, as shown in the illustrated embodiment, the rotor 18 may include a rotor shaft 34 coupled to the hub 20 for rotation therewith. The rotor shaft 34 may, in turn, be rotatably coupled to a generator shaft 36 of the generator 24 through a gearbox 38. As is generally understood, the rotor shaft 34 may provide a low speed, high torque input to the gearbox 38 in response to rotation of the rotor blades 22 and the hub 20. The gearbox 38 may then be configured to convert the low speed, high torque input to a high speed, low torque output to drive the generator shaft 36 and, thus, the generator 24.

The wind turbine 10 may also one or more pitch drive mechanisms 32 communicatively coupled to the wind turbine controller 26, with each pitch adjustment mechanism(s) 32 being configured to rotate a pitch bearing 40 and thus the individual rotor blade(s) 22 about its respective pitch axis 28. In addition, as shown, the wind turbine 10 may include one or more yaw drive mechanisms 42 configured to change the angle of the nacelle 16 relative to the wind (e.g., by engaging a yaw bearing 44 of the wind turbine 10 that is arranged between the nacelle 16 and the tower 12 of the wind turbine 10).

In addition, the wind turbine 10 may also include one or more sensors 66, 68 for monitoring various wind conditions of the wind turbine 10. For example, the incoming wind direction 52, wind speed, or any other suitable wind condition near of the wind turbine 10 may be measured, such as through use of a suitable weather sensor 66. Suitable weather sensors may include, for example, Light Detection and Ranging (“LIDAR”) devices, Sonic Detection and Ranging (“SODAR”) devices, anemometers, wind vanes, barometers, radar devices (such as Doppler radar devices) or any other sensing device which can provide wind directional information now known or later developed in the art. Still further sensors 68 may be utilized to measure additional operating parameters of the wind turbine 10, such as voltage, current, vibration, etc. as described herein.

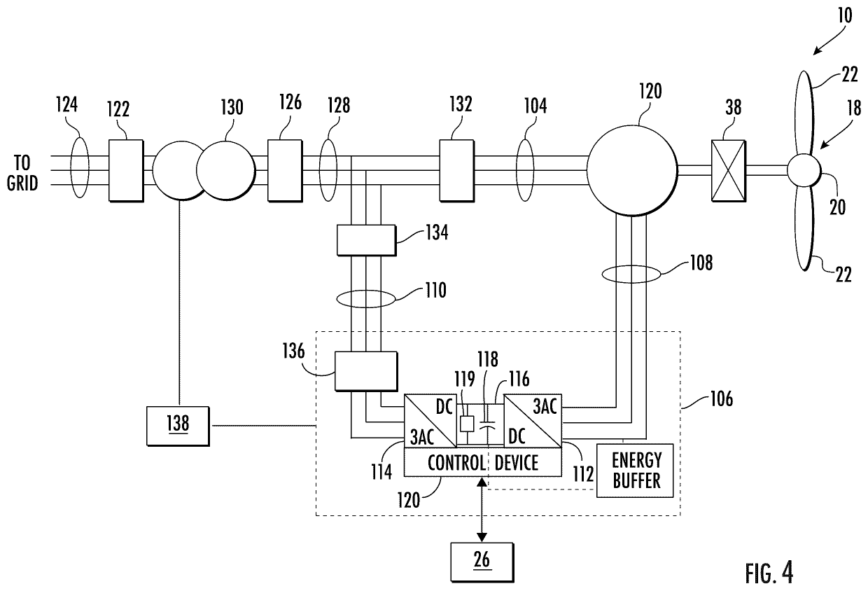

Referring now to FIG. 4, a schematic diagram of one embodiment of a wind turbine power system 100 is illustrated in accordance with aspects of the present disclosure. Although the present disclosure will generally be described herein with reference to the system 100 shown in FIG. 4, those of ordinary skill in the art, using the disclosures provided herein, should understand that aspects of the present disclosure may also be applicable in other power generation systems, and, as mentioned above, that the invention is not limited to wind turbine systems.

In the embodiment of FIG. 4 and as mentioned, the rotor 18 of the wind turbine 10 (FIG. 2) may, optionally, be coupled to the gearbox 38, which is, in turn, coupled to a generator 102, which may be a doubly fed induction generator (DFIG). As shown, the DFIG 102 may be connected to a stator bus 104. Further, as shown, a power converter 106 may be connected to the DFIG 102 via a rotor bus 108, and to the stator bus 104 via a line side bus 110. As such, the stator bus 104 may provide an output multiphase power (e.g., three-phase power) from a stator of the DFIG 102, and the rotor bus 108 may provide an output multiphase power (e.g., three-phase power) from a rotor of the DFIG 102. The power converter 106 may also include a rotor side converter (RSC) 112 and a line side converter (LSC) 114. The DFIG 102 is coupled via the rotor bus 108 to the rotor side converter 112. Additionally, the RSC 112 is coupled to the LSC 114 via a DC link 116 across which is a DC link capacitor 118. The LSC 114 is, in turn, coupled to the line side bus 110. Moreover, the wind turbine 10 may include an energy buffer 125, such as a dynamic brake (Db), which will be discussed in more detail herein. In addition, as shown, the power converter 106 may include an energy buffer 119, such as a battery energy storage device, one or more capacitors, or a resistive element (such as a dynamic brake), or combinations thereof.

The RSC 112 and the LSC 114 may be configured for normal operating mode in a three-phase, pulse width modulation (PWM) arrangement using one or more switching devices, such as insulated gate bipolar transistor (IGBT) switching elements. In addition, the power converter 106 may be coupled to a converter controller 120 in order to control the operation of the rotor side converter 112 and/or the line side converter 114 as described herein. It should be noted that the converter controller 120 may be configured as an interface between the power converter 106 and the turbine controller 26 and may include any number of control devices.

In typical configurations, various line contactors and circuit breakers including, for example, a grid breaker 122 may also be included for isolating the various components as necessary for normal operation of the DFIG 102 during connection to and disconnection from a load, such as the electrical grid 124. For example, a system circuit breaker 126 may couple a system bus 128 to a transformer 130, which may be coupled to the electrical grid 124 via the grid breaker 122. In alternative embodiments, fuses may replace some or all of the circuit breakers.

In operation, alternating current power generated at the DFIG 102 by rotating the rotor 18 is provided to the electrical grid 124 via dual paths defined by the stator bus 104 and the rotor bus 108. On the rotor bus side 108, sinusoidal multi-phase (e.g., three-phase) alternating current (AC) power is provided to the power converter 106. The rotor side converter 112 converts the AC power provided from the rotor bus 108 into direct current (DC) power and provides the DC power to the DC link 116. As is generally understood, switching elements (e.g., IGBTs) used in the bridge circuits of the rotor side converter 112 may be modulated to convert the AC power provided from the rotor bus 108 into DC power suitable for the DC link 116.

In addition, the line side converter 114 converts the DC power on the DC link 116 into AC output power suitable for the electrical grid 124. In particular, switching elements (e.g., IGBTs) used in bridge circuits of the line side converter 114 can be modulated to convert the DC power on the DC link 116 into AC power on the line side bus 110. The AC power from the power converter 106 can be combined with the power from the stator of DFIG 102 to provide multi-phase power (e.g., three-phase power) having a frequency maintained substantially at the frequency of the electrical grid 124 (e.g., 50 Hz or 60 Hz).

Additionally, various circuit breakers and switches, such as grid breaker 122, system circuit breaker 126, stator sync switch 132, converter breaker 134, and line contactor 136 may be included in the wind turbine power system 100 to connect or disconnect corresponding buses, for example, when current flow is excessive and may damage components of the wind turbine power system 100 or for other operational considerations. Additional protection components may also be included in the wind turbine power system 100.

Moreover, the power converter 106 may receive control signals from, for instance, the local control system 176 via the converter controller 120. The control signals may be based, among other things, on sensed states or operating characteristics of the wind turbine power system 100. Typically, the control signals provide for control of the operation of the power converter 106. For example, feedback in the form of a sensed speed of the DFIG 102 may be used to control the conversion of the output power from the rotor bus 108 to maintain a proper and balanced multi-phase (e.g., three-phase) power supply. Other feedback from other sensors may also be used by the controller(s) 120, 26 to control the power converter 106, including, for example, stator and rotor bus voltages and current feedbacks. Using the various forms of feedback information, switching control signals (e.g., gate timing commands for IGBTs), stator synchronizing control signals, and circuit breaker signals may be generated.

The power converter 106 also compensates or adjusts the frequency of the three-phase power from the rotor for changes, for example, in the wind speed at the hub 20 and the rotor blades 22. Therefore, mechanical and electrical rotor frequencies are decoupled and the electrical stator and rotor frequency matching is facilitated substantially independently of the mechanical rotor speed.

Under some states, the bi-directional characteristics of the power converter 106, and specifically, the bi-directional characteristics of the LSC 114 and RSC 112, facilitate feeding back at least some of the generated electrical power into generator rotor. More specifically, electrical power may be transmitted from the stator bus 104 to the line side bus 110 and subsequently through the line contactor 136 and into the power converter 106, specifically the LSC 114 which acts as a rectifier and rectifies the sinusoidal, three-phase AC power to DC power. The DC power is transmitted into the DC link 116. The capacitor 118 facilitates mitigating DC link voltage amplitude variations by facilitating mitigation of a DC ripple sometimes associated with three-phase AC rectification.

The DC power is subsequently transmitted to the RSC 112 that converts the DC electrical power to a three-phase, sinusoidal AC electrical power by adjusting voltages, currents, and frequencies. This conversion is monitored and controlled via the converter controller 120. The converted AC power is transmitted from the RSC 112 via the rotor bus 108 to the generator rotor. In this manner, generator reactive power control is facilitated by controlling rotor current and voltage.

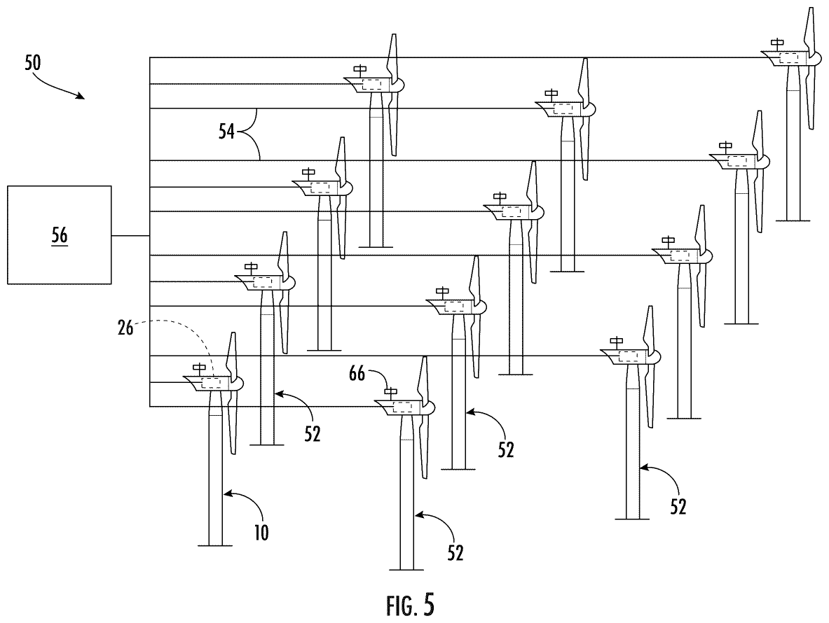

Referring now to FIG. 5, the wind turbine power system 100 described herein may be part of a wind farm 50. As shown, the wind farm 50 may include a plurality of wind turbines 52, including the wind turbine 10 described above, and an overall farm-level controller 56. For example, as shown in the illustrated embodiment, the wind farm 50 includes twelve wind turbines, including wind turbine 10. However, in other embodiments, the wind farm 50 may include any other number of wind turbines, such as less than twelve wind turbines or greater than twelve wind turbines. In one embodiment, the turbine controllers of the plurality of wind turbines 52 are communicatively coupled to the farm-level controller 56, e.g., through a wired connection, such as by connecting the turbine controller 26 through suitable communicative links 54 (e.g., a suitable cable). Alternatively, the turbine controllers may be communicatively coupled to the farm-level controller 56 through a wireless connection, such as by using any suitable wireless communications protocol known in the art. In further embodiments, the farm-level controller 56 is configured to send and receive control signals to and from the various wind turbines 52, such as for example, distributing real and/or reactive power demands across the wind turbines 52 of the wind farm 50.

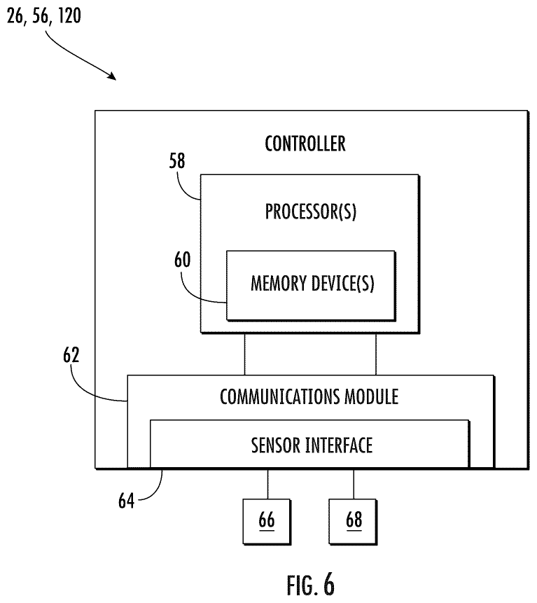

Referring now to FIG. 6, a block diagram of one embodiment of suitable components that may be included within the controller (such as any one of the converter controller 120, the turbine controller 26, and/or the farm-level controller 56 described herein) in accordance with example aspects of the present disclosure is illustrated. As shown, the controller may include one or more processor(s) 58, computer, or other suitable processing unit and associated memory device(s) 60 that may include suitable computer-readable instructions that, when implemented, configure the controller to perform various different functions, such as receiving, transmitting and/or executing wind turbine control signals (e.g., performing the methods, steps, calculations and the like disclosed herein).

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 60 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements.

Such memory device(s) 60 may generally be configured to store suitable computer-readable instructions that, when implemented by the processor(s) 58, configure the controller to perform various functions as described herein. Additionally, the controller may also include a communications interface 62 to facilitate communications between the controller and the various components of the wind turbine 10. An interface can include one or more circuits, terminals, pins, contacts, conductors, or other components for sending and receiving control signals. Moreover, the controller may include a sensor interface 64 (e.g., one or more analog-to-digital converters) to permit signals transmitted from the sensors 66, 68 to be converted into signals that can be understood and processed by the processor(s) 58.

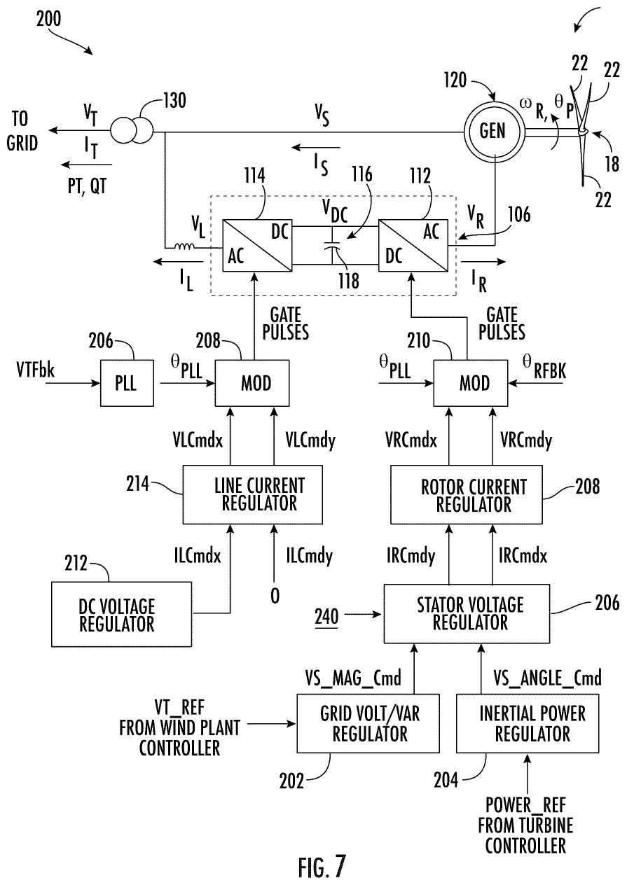

Referring now to FIG. 7, a schematic diagram of an embodiment of a grid forming power system 200 according to the present disclosure, particularly illustrating a one-line diagram of the double-fed wind turbine generator 102 with a high-level control structure for grid-forming characteristics. In particular, as shown, the grid forming power system 200 may include many of the same features of FIG. 4 described herein, with components having the same reference characters representing like components. Further, as shown, the grid forming power system 200 may include a control structure for controlling the line side converter that is similar to the control structure shown in FIG. 1. More particularly, as shown, the line side converter control structure may include a DC regulator 212 and a line current regulator 214. The DC regulator 212 is configured to generate line-side current commands for the line current regulator 214. The line current regulator 214 then generates line-side voltage commands for a modulator 218. The modulator 218 also receives an output (e.g., a phase-locked loop angle) from a phase-locked loop 216 to generate one or more gate pulses for the line side converter 114. The phase-locked loop 216 typically generates its output using a voltage feedback signal.

Furthermore, as shown, the grid forming power system 200 may also include a unique control structure for controlling the rotor side converter 112 using grid-forming characteristics. In particular, as shown in FIG. 7, the grid forming power system 200 may include a stator voltage regulator 206 for providing such grid-forming characteristics. In addition, as shown, the grid forming power system 200 may include a grid voltage/VAR regulator 202, an inertial power regulator 204, a rotor current regulator 208, and a modulator 210.

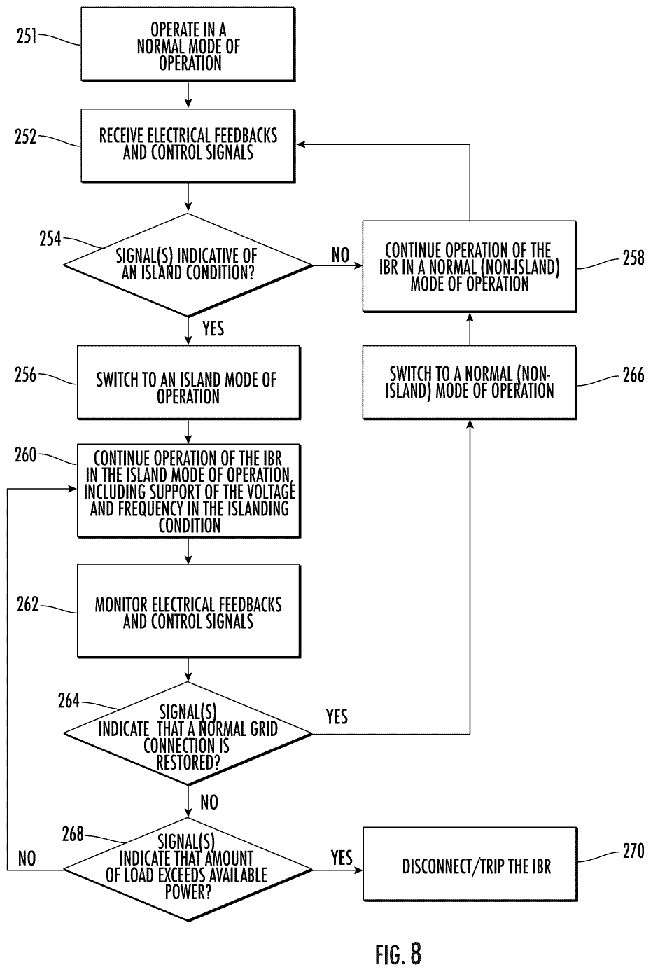

Referring now to FIGS. 8-10, the present disclosure is directed to a method 250 and a system 300 for controlling a grid-forming inverter-based resource connected to an electrical grid according to the present disclosure. In particular, FIG. 8 illustrates a flow diagram of an embodiment of a method 250 for controlling a grid-forming inverter-based resource connected to an electrical grid according to the present disclosure. In general, the method 250 is described herein with reference to the wind turbine 10 and the wind farm 50 of FIGS. 2-7. However, it should be appreciated that the disclosed method 250 may be implemented with any inverter-based resources in addition to wind turbines having any other suitable configurations. In addition, although FIG. 8 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown at (251), the method 250 includes operating grid-forming inverter-based resource in a normal mode of operation. As shown at (252), the method 250 includes receiving, e.g., via a controller, one or more electrical feedbacks and control signals. As shown at (254), the method 250 includes determining whether the one or more electrical feedbacks and control signals are indicative of an islanding condition occurring in the grid-forming inverter-based resource. If not, as shown at (258), the method includes continuing operation of the grid-forming inverter-based resource in the normal mode of operation (e.g., a non-island mode). Upon the one or more electrical feedbacks and control signals being indicative of the islanding condition, however, as shown at (256), the method 250 includes switching to an island mode of operation for the grid-forming inverter-based resource. Thus, as shown at 260, the island mode of operation includes continuing operation of the grid-forming inverter-based resource in the islanding condition, including e.g., support of voltage and frequency in the island. Moreover, as shown at (262), the method 250 includes continuously monitoring the one or more electrical feedbacks and control signals. Thus, as shown at (264) and (268), the method 150 includes continuing operation of the grid-forming inverter-based resource in the islanding condition for as long as the one or more electrical feedbacks and control signals indicate the islanding condition (264) and an amount of loading is within the available power/energy of the inverter-based resource (268). Moreover, as shown at (266), the method 250 includes reverting to the normal mode of operation when the one or more electrical feedbacks and control signals indicate that the electrical grid is restored (for example, if a) frequency feedback stays close to nominal for a predetermined period of time, b) if rate of change of frequency has been below a threshold for a predetermined period of time, c) expected angle/power sensitivity has been restored, or d) combinations of these). In another embodiment, if the one or more electrical feedbacks and control signals indicate that the electrical grid is not restored and the loading exceeds the available power/energy, the method 250 may include shutting down or tripping the inverter-based resource (e.g., the WTG). In some embodiments, indications that the load exceeds available power/energy may be a low or decreasing operating speed (such as a WTG), low state of charge in a battery, or low DC voltage in systems equipped with capacitive energy storage on DC link.

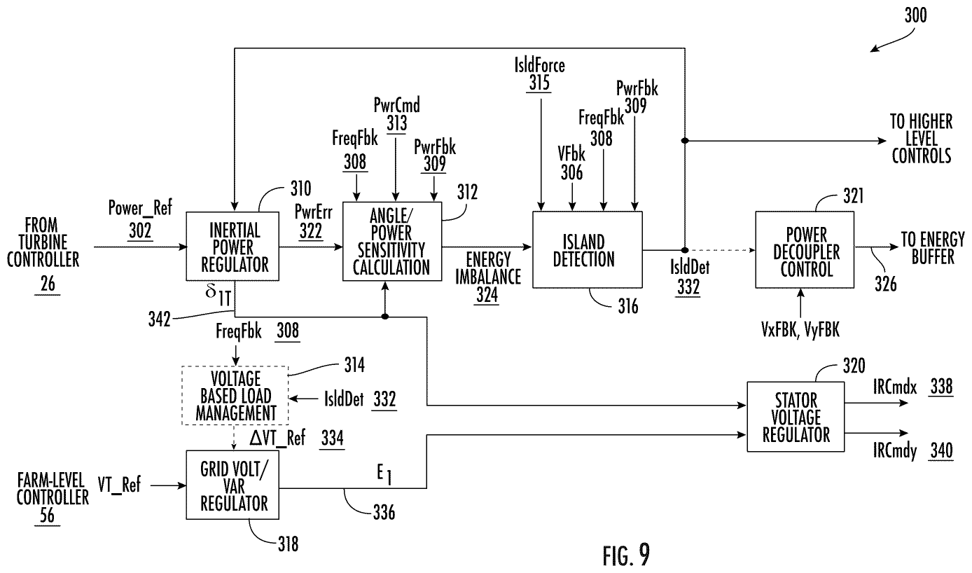

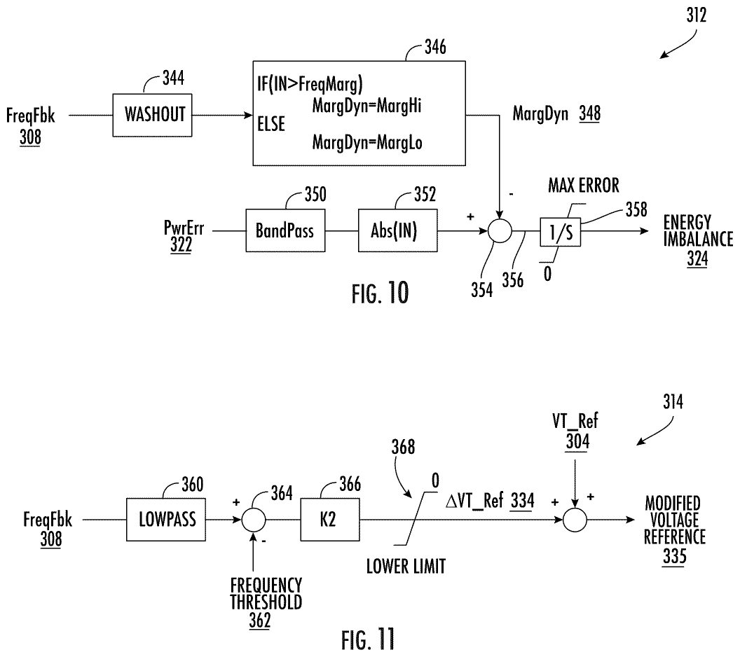

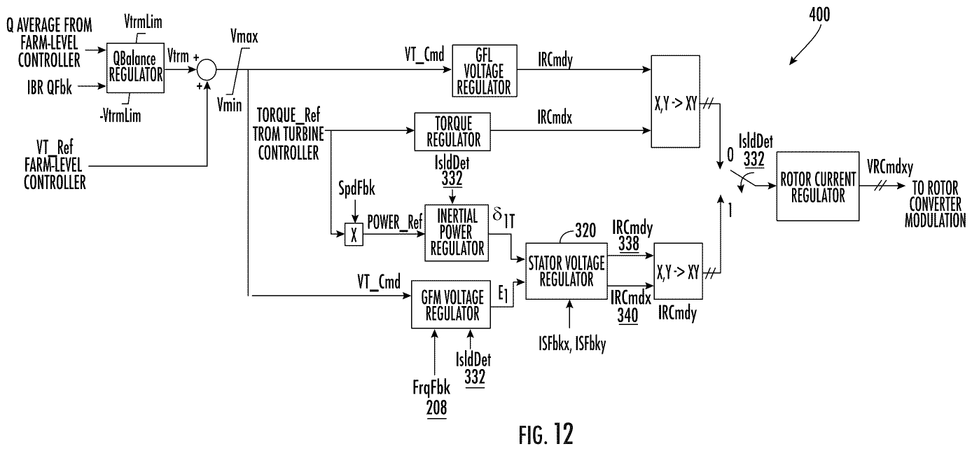

The method 250 of FIG. 8 can be better understood with reference to FIGS. 9-12. In particular, FIGS. 9-12 illustrate schematic diagrams of the system 300 for controlling a grid-forming inverter-based resource connected to an electrical grid according to the present disclosure. More specifically, FIG. 9 illustrates a schematic diagram of an embodiment of a GFM WTG with islanding detection and continuous operation control being implemented in the system 300 according to the present disclosure. FIG. 10 illustrates a schematic diagram of an embodiment of an angle/power sensitivity calculation module 312 of the system 300 according to the present disclosure. FIG. 11 illustrates a schematic diagram of an embodiment of an angle/power sensitivity calculation of a voltage-based load management module 314 of the system 300 according to the present disclosure. FIG. 12 illustrates a schematic diagram of an embodiment of a system for operating a GFL WTG that may switch to GFM controls in an island condition according to the present disclosure.

As shown particularly in FIG. 9, the system 300 may include an inertial power regulator 310, an angle/power sensitivity calculation module 312, a voltage-based load management function 314, an island detection module 316, a grid voltage/VAR regulator 318, and/or a stator voltage regulator 320, and/or a power decoupler control function 321. Furthermore, as shown, the system 300 is configured to receive a plurality of inputs. In particular embodiments, as shown, the plurality of inputs may include, for example, a power reference 302 (e.g., Power_Ref) (e.g., from turbine controller 26) and a voltage reference 304 (e.g., VT_Ref) (e.g., from the farm-level controller 56), a voltage feedback signal 306 (e.g., VFbk), a frequency feedback signal 308 (e.g., FreqFbk), a power command 313 (e.g., PwrCmd), a power feedback feedback signal 309 (e.g., PwrFbk), and/or any other suitable input. More specifically, as shown, in an embodiment, the inertial power regulator 310 of the system 300 is configured to determine a power error signal 322 (e.g., PwrErr) based on the power reference 302. The angle/power sensitivity calculation module 312 can then monitor either the power error signal 322 or check for a certain relationship between an angle command SIT 342 and the power feedback signal 309 (or the frequency feedback signal 308 or the power command 313) to determine whether power has become less sensitive to angle changes (which is a characteristic of an island system). Integrating the difference between an expected power change due to angle and actual power change (or just using PwrErr as shown in FIG. 10) produces an energy imbalance signal 324. The energy imbalance signal 324 is thus sent to the island detection module 316.

Moreover, as shown, the island detection module 316 is configured to produce a Boolean signal 322 (e.g., IsldDet) indicative of whether an island condition is detected (1) or not (0). This Boolean signal 322 is used to decide whether to switch to an island operating mode. This signal may be used to enable the power decoupler control function 321 and/or the voltage-based load management function 314, passed as a notification to higher level controls, or change parameters of the inertial power regulator 310. Additionally, if the inverter-based resource normally operates using grid-following controls, this Boolean signal may be used to switch to a grid-forming control structure. If the inverter-based resource is a wind turbine, the Boolean signal may also be used to operate the turbine in such a way that speed is regulated primarily or exclusively through blade pitch while the electrical loads predominantly determine the power output of the wind turbine. Furthermore, the island operating mode may instead be forced by signals supplied by an external or higher level control (e.g. IsldForce). In this way, the inverter-based resource may either decide to switch to an island mode of operation based on its own local signals or be forced by higher level controls based upon separate criteria.

Details of this calculation are illustrated in FIG. 10. In particular, as shown, a schematic diagram of an embodiment of the angle/power sensitivity calculation module 312 of the system 300 according to the present disclosure is illustrated. As shown and as mentioned, the angle/power sensitivity calculation module 312 receives the power error signal 322 from the inertial power regulator 310 and the frequency feedback signal 308. More specifically, in an embodiment, the frequency feedback signal 308 may be filtered via a washout filter 344. Moreover, as shown at 346, one or more functions may be applied to the filtered frequency feedback signal 308 to generate a dynamic margin signal 348 (e.g., MargDyn). In such embodiments, the dynamic margin signal 348 can be adjusted so that when the output of box 352 is below the dynamic margin signal 348, the energy imbalance is always zero. This helps to distinguish a true island event from other types of grid events that may temporarily result in angle/power insensitivity. In addition, the power error signal 322 may also be filtered, e.g., via a bandpass filter 350. Further, as shown at 352, an absolute value may be applied to the filtered power error signal 322, with an output being compared to the MargDyn 348 as shown at 354. An output 356 of comparator 354 can then be integrated as shown at 358 to determine the energy imbalance signal 324.

In addition, and referring back to FIG. 9, the voltage-based load management function 314 is configured to generate a voltage deviation reference 334 (e.g., ΔVT_Ref) for the grid voltage/VAR regulator 318. The grid voltage/VAR regulator 318 is thus configured to determine a modified voltage reference as a function of the voltage reference 304 and the voltage deviation reference 334. Accordingly, as shown in FIG. 9, the stator voltage regulator 320 is configured to determine one or more current commands 338, 340 (e.g., IRCmdx, IRCmdy) based on SIT 342 and the voltage command signal E1 336.

The voltage-based load management function 314 may reduce voltage in the island condition if frequency drops too low. Decreasing voltage in islands with a significant portion of load being resistive can be effective at balancing load/generation (and slowing down or stopping the drop in frequency). Operation of this function can also consider voltage limits of the inverter-based resource and coordination with higher level plant controls to avoid ‘fighting’ this function.

An example of this function is shown in FIG. 11. In particular, as shown, a schematic diagram of an embodiment of the voltage-based load management function 314 of the system 300 according to the present disclosure is illustrated. As shown and as mentioned, the voltage-based load management function 314 receives the frequency feedback signal 308. More specifically, in an embodiment, the frequency feedback signal 308 may be filtered via a low pass filter 360. Moreover, as shown at 364, the filtered frequency feedback signal 308 may be compared to a frequency threshold 362. A gain 366 can then be applied to an output of the comparator 364. Moreover, as shown, an output of the gain 366 may be limited via limiter 368 to generate the voltage deviation reference 334 (e.g., AVT_Ref).

Thus, as shown, the voltage deviation reference 334 can then be compared to the voltage reference signal 304 to generate a modified voltage reference 335 that is used by the grid Volt/VAR regulator 318.

Moreover, and referring back to FIG. 9, the system 300 is configured to determine whether the islanding condition is occurring in the grid-forming inverter-based resource by determining the islanding detection signal 332 (e.g., IsldDet). More specifically, as shown, the island detection module 316 is configured to determine the islanding detection signal 332 as a function of the voltage signal 306, the frequency signal 308, and the energy imbalance signal 324. Accordingly, as shown, the islanding detection signal 332 can be sent to higher level controls.

In addition, as shown, the islanding detection signal 332 can be sent to and used by the voltage-based load management function 314 and/or the power decoupler control function 321. Thus, in an embodiment, as shown, the power decoupler control function 321 is configured to generate an energy buffer signal 326 as a function of the voltage feedbacks (e.g., VxFBK, VyFBK in FIG. 9), the energy imbalance signal 324, and/or the islanding detection signal 332.

Referring now to FIG. 12, a schematic diagram of an embodiment of a system 400 for operating a GFL WTG that may switch to GFM controls in an island condition is illustrated according to the present disclosure. In particular, as shown, the system 400 utilizes existing islanding detection logic, but instead of tripping the WTG, the functions switch to an islanding operating mode of operation based on the islanding detection signal 332 (e.g., IsldDet) determined according to the embodiments described herein. In this case, switching to the island mode involves switching to GFM control mode (e.g., when IsldDet 332 becomes true) as shown in FIG. 12.

In certain embodiments, one or more key aspects of the GFL to GFM mode switching are the following: in GFL mode, a voltage reference (VT_Ref) from a farm-level controller together with a Q Balance regulator provides the voltage command (VT_Cmd) to the GFL voltage regulator. In GFM mode, the voltage command may be based on a voltage reference from a farm-level control added to a voltage trim signal (e.g., Vtrm)(e.g. the voltage commands to the GFM and GFL controls are the same in this embodiment). Moreover, voltage control is maintained in both GFL and GFM modes. Further, rotor current commands are determined by the stator voltage regulator 320 in GFM mode, whereas in GFL the rotor current commands are determined directly by the GFL voltage regulator and torque regulator. In addition, various variables and integrators in the inertial power regulator 310 and the GFM voltage regulator may be continuously preset while operating in GFL mode to avoid large jumps in control quantities when switching from GFL to GFM (and vice versa for switching from GFM to GFL).

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Further aspects of the invention are provided by the subject matter of the following clauses:

A method for controlling an inverter-based resource connected to an electrical grid, the method comprising: operating the inverter-based resource in a normal mode of operation; receiving, via a controller, one or more electrical feedbacks and control signals; determining, via the controller, whether the one or more electrical feedbacks and control signals are indicative of an islanding condition occurring in the inverter-based resource; upon the one or more electrical feedbacks and control signals being indicative of the islanding condition, switching to an island mode of operation for the inverter-based resource, wherein the island mode of operation comprises: continuously monitoring the one or more electrical feedbacks and control signals; continuing operation of the inverter-based resource in the island mode of operation for as long as the one or more electrical feedbacks and control signals indicate the islanding condition and an amount of loading is below at least one of available power or energy at the inverter-based resource; and reverting to the normal mode of operation when the one or more electrical feedbacks and control signals indicate that the electrical grid is restored.

The method of any preceding clause, wherein the one or more electrical feedbacks and control signals comprise at least one of a voltage feedback signal, a frequency feedback signal, a power feedback signal, a current feedback signal, a control feedback signal, or a control command signal.

The method of any preceding clause, wherein determining whether the one or more electrical feedbacks and control signals are indicative of the islanding condition occurring in the inverter-based resource further comprises: determining, via an inertial power regulator, a power error signal as a function of at least one of the power reference signal or an angle command signal; and determining, via an angle/power sensitivity calculation module, an energy imbalance signal based at least in part on the power error signal; determining, via an island detection module, an islanding detection signal based, at least in part, on the energy imbalance signal; and determining whether the one or more electrical feedbacks and control signals are indicative of the islanding condition occurring in the inverter-based resource based on the islanding detection signal.

The method of any preceding clause, wherein determining, via the angle/power sensitivity calculation module, the energy imbalance signal further comprises: determining, via the angle/power sensitivity calculation module, the energy imbalance signal based on at least one of the power error signal, the frequency feedback signal, the power command, and the power feedback signal.

The method of any preceding clause, wherein determining, via the island detection module, an islanding detection signal based, at least in part, on the energy imbalance signal further comprises: determining, via the island detection module, the islanding detection signal based on at least one of the energy imbalance signal, the voltage feedback signal, the frequency feedback signal, and the power feedback signal.

The method of any preceding clause, further comprising generating, via a voltage-based load management function, a voltage deviation reference for a grid voltage/VAR regulator as a function of the frequency feedback signal and the islanding detection signal.

The method of any preceding clause, wherein generating, via the voltage-based load management function, the voltage deviation reference for the grid voltage/VAR regulator as the function of the frequency feedback signal and the islanding detection signal further comprises: in response to the islanding detection signal indicating the islanding condition occurring in the inverter-based resource, filtering the frequency feedback signal; comparing the filtered frequency signal to a frequency threshold; applying a gain to the comparison; and applying, via a limiter, one or more limits to the comparison.

The method of any preceding clause, further comprising: determining, via the grid voltage/VAR regulator, a voltage error signal as a function of the voltage reference signal and the voltage deviation reference; and determining, via a stator voltage regulator, one or more current commands based on the voltage error signal and an angle command from the inertial power regulator.

The method of any preceding clause, wherein switching to the island mode of operation further comprises at least one of: switching from a grid-following mode of operation to a grid forming mode of operation; and sending the islanding detection signal to a system-level controller.

The method of any preceding clause, further comprising forcing the island mode of operation based on a signal received from a system-level controller.

The method of any preceding clause, wherein the inverter-based resource is a wind turbine power system.

The method of any preceding clause, wherein the inverter-based resource is a grid forming inverter-based resource.

A wind turbine, comprising: a generator; a power converter coupled to the generator; and a controller comprising at least one processor configured to perform a plurality of operations, the plurality of operations comprising: receiving one or more electrical feedbacks and control signals; determining whether the one or more electrical feedbacks and control signals are indicative of an islanding condition occurring in the wind turbine; upon the one or more electrical feedbacks and control signals being indicative of the islanding condition, switching to an island mode of operation for the wind turbine, wherein the island mode of operation comprises: continuously monitoring the one or more electrical feedbacks and control signals; continuing operation of the wind turbine in the island mode of operation for as long as the one or more electrical feedbacks and control signals indicate the islanding condition and an amount of loading is below at least one of available power or energy at the inverter-based resource; and reverting to the normal mode of operation when the one or more electrical feedbacks and control signals indicate that the electrical grid is restored.

The wind turbine of any preceding clause, wherein the one or more electrical feedbacks and control signals comprise at least one of a voltage feedback signal, a frequency feedback signal, a power feedback signal, a current feedback signal, or a control feedback signal.

The wind turbine of any preceding clause, wherein the controller further comprises an inertial power regulator, an angle/power sensitivity calculation module, and an island detection module, wherein determining whether the one or more electrical feedbacks and control signals are indicative of the islanding condition occurring in the wind turbine further comprises: determining, via the inertial power regulator, a power error signal as a function of at least one of the power reference signal or an angle command; and determining, via the angle/power sensitivity calculation module, an energy imbalance signal based at least in part on the power error signal; determining, via the island detection module, an islanding detection signal based, at least in part, on the energy imbalance signal; and determining whether the one or more electrical feedbacks and control signals are indicative of the islanding condition occurring in the wind turbine based on the islanding detection signal.

The wind turbine of any preceding clause, wherein determining, via the angle/power sensitivity calculation module, the energy imbalance signal further comprises: determining, via the angle/power sensitivity calculation module, the energy imbalance signal based on the power error signal, the frequency feedback signal, and the power feedback signal.

The wind turbine of any preceding clause, wherein determining, via the island detection module, an islanding detection signal based, at least in part, on the energy imbalance signal further comprises: determining, via the island detection module, the islanding detection signal based on at least one of the energy imbalance signal, the voltage feedback signal, the frequency feedback signal, the power command, and the power feedback signal.

The wind turbine of any preceding clause, wherein the controller further comprises a voltage-based load management function, the plurality of operations further comprising: generating, via the voltage-based load management function, a voltage deviation reference for a grid voltage/VAR regulator as a function of at least one of the frequency feedback signal and the islanding detection signal.

The wind turbine of any preceding clause, wherein the plurality of operations further comprises: generating, via the voltage-based load management function, the voltage deviation reference for the grid voltage/VAR regulator as the function of the frequency feedback signal and the islanding detection signal further comprises: in response to the islanding detection signal indicating the islanding condition occurring in the wind turbine, filtering the frequency feedback signal; comparing the filtered frequency signal to a frequency threshold; applying a gain to the comparison; applying, via a limiter, one or more limits to the comparison; determining, via the grid voltage/VAR regulator, a voltage error signal as a function of the voltage reference signal and the voltage deviation reference; and determining, via a stator voltage regulator, one or more current commands based on the voltage error signal and an angle command from the inertial power regulator.

The wind turbine of any preceding clause, wherein switching to the island mode of operation further comprises at least one of: switching from a grid-following mode of operation to a grid forming mode of operation; sending the islanding detection signal to a system-level controller; enabling a power decoupler controller module to manage drivetrain oscillations of the wind turbine; and operating the wind turbine such that a rotor speed is controlled by pitch controls and an electric power/torque is used to supply the grid load demands.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for controlling an inverter-based resource connected to an electrical grid, the method comprising:
operating the inverter-based resource in a normal mode of operation;
receiving, via a controller, one or more electrical feedbacks and control signals;
determining, via the controller, whether the one or more electrical feedbacks and control signals are indicative of an islanding condition occurring in the inverter-based resource;
upon the one or more electrical feedbacks and control signals being indicative of the islanding condition, switching to an island mode of operation for the inverter-based resource, wherein the island mode of operation comprises:
continuously monitoring the one or more electrical feedbacks and control signals; and
continuing operation of the inverter-based resource in the island mode of operation for as long as the one or more electrical feedbacks and control signals indicate the islanding condition and an amount of loading is below at least one of available power or energy at the inverter-based resource; and
reverting to the normal mode of operation when the one or more electrical feedbacks and control signals indicate that the electrical grid is restored.

2. The method of claim 1, wherein the one or more electrical feedbacks and control signals comprise at least one of a voltage feedback signal, a frequency feedback signal, a power feedback signal, a current feedback signal, a control feedback signal, or a control command signal.

3. The method of claim 2, wherein determining whether the one or more electrical feedbacks and control signals are indicative of the islanding condition occurring in the inverter-based resource further comprises:
determining, via an inertial power regulator, a power error signal as a function of at least one of the power reference signal or an angle command signal; and
determining, via an angle/power sensitivity calculation module, an energy imbalance signal based at least in part on the power error signal;
determining, via an island detection module, an islanding detection signal based, at least in part, on the energy imbalance signal; and
determining whether the one or more electrical feedbacks and control signals are indicative of the islanding condition occurring in the inverter-based resource based on the islanding detection signal.

4. The method of claim 3, wherein determining, via the angle/power sensitivity calculation module, the energy imbalance signal further comprises:
determining, via the angle/power sensitivity calculation module, the energy imbalance signal based on at least one of the power error signal, the frequency feedback signal, the power command, and the power feedback signal.

5. The method of claim 3, wherein determining, via the island detection module, an islanding detection signal based, at least in part, on the energy imbalance signal further comprises:
determining, via the island detection module, the islanding detection signal based on at least one of the energy imbalance signal, the voltage feedback signal, the frequency feedback signal, and the power feedback signal.

6. The method of claim 3, further comprising generating, via a voltage-based load management function, a voltage deviation reference for a grid voltage/VAR regulator as a function of the frequency feedback signal and the islanding detection signal.

7. The method of claim 6, wherein generating, via the voltage-based load management function, the voltage deviation reference for the grid voltage/VAR regulator as the function of the frequency feedback signal and the islanding detection signal further comprises:
in response to the islanding detection signal indicating the islanding condition occurring in the inverter-based resource, filtering the frequency feedback signal;
comparing the filtered frequency signal to a frequency threshold;
applying a gain to the comparison; and
applying, via a limiter, one or more limits to the comparison.

8. The method of claim 6, further comprising:
determining, via the grid voltage/VAR regulator, a voltage error signal as a function of the voltage reference signal and the voltage deviation reference; and
determining, via a stator voltage regulator, one or more current commands based on the voltage error signal and an angle command from the inertial power regulator.

9. The method of claim 1, wherein switching to the island mode of operation further comprises at least one of:
switching from a grid-following mode of operation to a grid forming mode of operation; and
sending the islanding detection signal to a system-level controller.

10. The method of claim 1, further comprising forcing the island mode of operation based on a signal received from a system-level controller.

11. The method of claim 1, wherein the inverter-based resource is a wind turbine power system.

12. The method of claim 1, wherein the inverter-based resource is a grid forming inverter-based resource.

13. A wind turbine, comprising:
a generator;
a power converter coupled to the generator; and
a controller comprising at least one processor configured to perform a plurality of operations, the plurality of operations comprising:
receiving one or more electrical feedbacks and control signals;
determining whether the one or more electrical feedbacks and control signals are indicative of an islanding condition occurring in the wind turbine;
upon the one or more electrical feedbacks and control signals being indicative of the islanding condition, switching to an island mode of operation for the wind turbine, wherein the island mode of operation comprises:
continuously monitoring the one or more electrical feedbacks and control signals;
continuing operation of the wind turbine in the island mode of operation for as long as the one or more electrical feedbacks and control signals indicate the islanding condition and an amount of loading is below at least one of available power or energy at the inverter-based resource; and
reverting to the normal mode of operation when the one or more electrical feedbacks and control signals indicate that the electrical grid is restored.

14. The wind turbine of claim 13, wherein the one or more electrical feedbacks and control signals comprise at least one of a voltage feedback signal, a frequency feedback signal, a power feedback signal, a current feedback signal, or a control feedback signal.

15. The wind turbine of claim 14, wherein the controller further comprises an inertial power regulator, an angle/power sensitivity calculation module, and an island detection module, wherein determining whether the one or more electrical feedbacks and control signals are indicative of the islanding condition occurring in the wind turbine further comprises:
determining, via the inertial power regulator, a power error signal as a function of at least one of the power reference signal or an angle command; and
determining, via the angle/power sensitivity calculation module, an energy imbalance signal based at least in part on the power error signal;
determining, via the island detection module, an islanding detection signal based, at least in part, on the energy imbalance signal; and
determining whether the one or more electrical feedbacks and control signals are indicative of the islanding condition occurring in the wind turbine based on the islanding detection signal.

16. The wind turbine of claim 15, wherein determining, via the angle/power sensitivity calculation module, the energy imbalance signal further comprises:
determining, via the angle/power sensitivity calculation module, the energy imbalance signal based on the power error signal, the frequency feedback signal, and the power feedback signal.

17. The wind turbine of claim 15, wherein determining, via the island detection module, an islanding detection signal based, at least in part, on the energy imbalance signal further comprises:
determining, via the island detection module, the islanding detection signal based on at least one of the energy imbalance signal, the voltage feedback signal, the frequency feedback signal, the power command, and the power feedback signal.

18. The wind turbine of claim 15, wherein the controller further comprises a voltage-based load management function, the plurality of operations further comprising:
generating, via the voltage-based load management function, a voltage deviation reference for a grid voltage/VAR regulator as a function of at least one of the frequency feedback signal and the islanding detection signal.

19. The wind turbine of claim 18, wherein the plurality of operations further comprises:
generating, via the voltage-based load management function, the voltage deviation reference for the grid voltage/VAR regulator as the function of the frequency feedback signal and the islanding detection signal further comprises:
in response to the islanding detection signal indicating the islanding condition occurring in the wind turbine, filtering the frequency feedback signal;
comparing the filtered frequency signal to a frequency threshold;
applying a gain to the comparison;
applying, via a limiter, one or more limits to the comparison;
determining, via the grid voltage/VAR regulator, a voltage error signal as a function of the voltage reference signal and the voltage deviation reference; and
determining, via a stator voltage regulator, one or more current commands based on the voltage error signal and an angle command from the inertial power regulator.

20. The wind turbine of claim 15, wherein switching to the island mode of operation further comprises at least one of:
switching from a grid-following mode of operation to a grid forming mode of operation;
sending the islanding detection signal to a system-level controller;
enabling a power decoupler controller module to manage drivetrain oscillations of the wind turbine; and
operating the wind turbine such that a rotor speed is controlled by pitch controls and an electric power/torque is used to supply the grid load demands.
